(19) United States
(12) Patent Application Publication
(10) Pub. No.: US 2010/0096837 A1
(43) Pub. Date: Apr. 22, 2010

(54) Trailer Coupler Assembly Including A Sacrificial Anode

(76) Inventors: Rodney P. Ehrlich, Indianapolis, IN (US); David P. Kunkel, Lebanon, IN (US)

Correspondence Address: BARNES & THORNBURG LLP, 11 SOUTH MERIDIAN, INDIANAPOLIS, IN, 46204, US

(21) Appl. No.: 12/582,267

(22) Filed: Oct. 20, 2009

Related U.S. Application Data
(60) Provisional application No. 61/107,200, filed on Oct. 21, 2008.

(51) Int. Cl. B60D 1/58; C23F 13/00

(52) U.S. Cl. 280/507; 204/196.3; 205/724

(57) ABSTRACT

A trailer coupler assembly includes a coupler grid plate, a support bracket coupled to the coupler grid plate, and a kingpin coupled to the coupler grid plate and the support bracket. The kingpin is positioned to extend below a bottom surface of the coupler grid plate. The trailer coupler assembly further includes a sacrificial anode coupled to one of the coupler grid plate and the support bracket in order to retard corrosion of one or more of the coupler grid plate, the support bracket, and the kingpin.

This application claims priority under 35 U.S.C. §119(e) to U.S. Provisional Patent Application Ser. No. 61/107,200, filed Oct. 21, 2008 entitled TRAILER COUPLER ASSEMBLY INCLUDING A SACRIFICIAL ANODE, the entirety of which is hereby incorporated by reference herein.

### FIELD OF THE INVENTION

The present invention relates generally to a trailer coupler assembly used to connect trailers to vehicles.

### BACKGROUND

Trailer coupler assemblies are used to connect trailers to vehicles, such as semi-tractors, trucks, automobiles, or railway cars, for movement of the trailer. One or more components of conventional trailer coupler assemblies may corrode and wear over time due in part to corrosive forces, such as galvanic corrosion, for example.

### SUMMARY

The present invention may comprise one or more of the features recited in the attached claims, and/or one or more of the following features and combinations thereof. Various illustrative embodiments of a trailer coupler assembly are provided. According to a first aspect of the present disclosure, a trailer coupler assembly includes a coupler grid plate, a support bracket coupled to the grid plate, a kingpin coupled to the coupler grid plate and the support bracket, the kingpin being positioned to extend below a bottom surface of the coupler grid plate, and a sacrificial anode coupled to one of the coupler grid plate and the support bracket.

In one illustrative embodiment, the sacrificial anode may be coupled to the coupler grid plate. Illustratively, the sacrificial anode may be removably coupled to the coupler grid plate by a bolt, for example. Further illustratively, the sacrificial anode may be positioned between two side arms of the support bracket.

In another illustrative embodiment, the trailer coupler assembly includes an anode assembly including a base plate received within a cut-out portion of the coupler grid plate, and a fastener configured to removably fasten base plate to the coupler grid plate. Illustratively, the sacrificial anode is coupled to the base plate. Further illustratively, the fastener of the anode assembly may include a tab coupled to the coupler grid plate and removably coupled to the base plate. The base plate and the coupler grid plate may be substantially flush with each other when the base plate is coupled to the coupler grid plate.

In another illustrative embodiment, the kingpin may be made of a first metal or metal alloy and the sacrificial anode may be made of a second metal or metal alloy having a lower reduction potential than the first metal or metal alloy. Illustratively, the sacrificial anode may include one of zinc, magnesium, and aluminum. Further illustratively, the sacrificial anode may be is a block of zinc.

In yet another illustrative embodiment, the sacrificial anode may be coupled to the support bracket. Illustratively, the sacrificial anode may be a washer coupled to the support bracket by a fastener received through an aperture of the washer and an aperture of the support bracket. The wash may include zinc.

In still another illustrative embodiment, the trailer coupler assembly may include a base plate removably coupled to the coupler grid plate. Illustratively, the sacrificial anode may be coupled to the base plate.

According to yet another embodiment of the present disclosure, a sacrificial anode assembly is configured to be coupled to a coupler grid plate of a trailer. The sacrificial anode assembly includes a base plate configured to be received within an aperture formed in the coupler grid plate. The sacrificial anode assembly further includes a fastener including a tab configured to be coupled to the coupler grid plate and removably coupled to the base plate to removably secure the base plate to the coupler grid plate. Finally, the sacrificial anode assembly includes a sacrificial anode coupled to the base plate.

According to still another embodiment of the present disclosure, a method of preventing corrosion of a trailer coupler assembly includes forming a cut-out portion in a coupler grid plate of the trailer coupler assembly, positioning a base plate within the cut-out portion of the coupler grid plate, removably coupling the base plate to the coupler grid plate, and coupling a first sacrificial anode to the base plate. Illustratively, preventing corrosion of the trailer coupler assembly may also include removing the base plate from the coupler grid plate, replacing the first sacrificial anode on the base plate with a second sacrificial anode after the first sacrificial anode has been used, and recoupling the base plate to the coupler grid plate. Further illustratively, the base plate may be removably coupled to the coupler grid plate by coupling a fastener to the coupler grid plate and coupling the base plate to the fastener. In particular, the fastener may be a tab having a first end welded to the coupler grid plate and a second end removably coupled to the base plate.

### BRIEF DESCRIPTION OF THE DRAWINGS

FIG. 1A is a top cut-away view of a trailer coupler assembly of the present disclosure coupled to a portion of a trailer.

FIG. 1B is a cross-sectional view taken along line B-B of FIG. 1.

FIG. 2 is a top perspective view of the trailer coupler assembly showing two zinc block sacrificial anodes of the assembly.

FIG. 3 is an exploded, side perspective view of the trailer coupler assembly of FIGS. 1A-2.

FIG. 4 is an exploded perspective view of a portion of another trailer coupler assembly including zinc washer sacrificial anodes coupled to a support bracket of the assembly.

FIG. 5 is an exploded perspective view of a portion of yet another trailer coupler assembly including zinc block sacrificial anodes coupled to a support bracket of the assembly.

FIG. 6 is a side perspective view of still another trailer coupler assembly including zinc block sacrificial anode assemblies coupled to a coupler grid plate of the assembly.

FIG. 7 is an exploded perspective view of one of the zinc block sacrificial anode assemblies shown in FIG. 6.

FIG. 8 is a cross-sectional view of the assembled zinc block sacrificial anode assembly of FIG. 7.

FIG. 9 is a side perspective view of yet another trailer coupler assembly including zinc block sacrificial anodes positioned within an aperture formed in a coupler grid plate of the assembly.

FIG. 10 is a cross-sectional view of one of the zinc block sacrificial anodes of FIG. 9 coupled to the coupler grid plate of the assembly.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same. While the concepts of this disclosure are described in relation to a trailer coupler assembly for use in connecting a trailer to a semi-tractor or a railway car, it will be understood that they are equally applicable to other trailers and trailer coupler assemblies generally, and more specifically to trailer coupler assemblies used with conventional box, van, or flatbed type trailers, examples of which include, but should not be limited to, straight truck bodies, small personal and/or commercial trailers and the like. Further, the concepts of this disclosure are similarly applicable for use with any vehicle underbody or undercarriage, for any type of vehicle, in applications where it is desirable to reduce corrosion and/or corrosion potential.

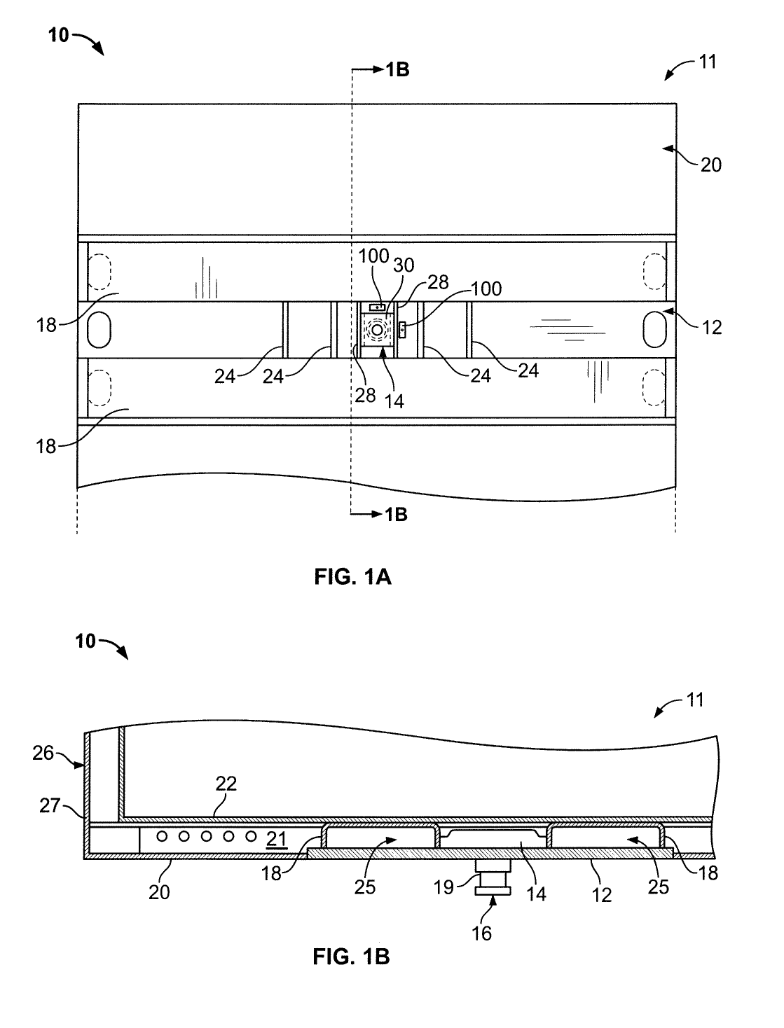

A trailer coupler assembly 10 is coupled to a trailer 11 such that the trailer 11 may be connected to a semi-tractor (not shown) or other suitable vehicle. Illustratively, the trailer coupler assembly 10 is provided in and coupled to a floor region 21 (shown in FIG. 1B) of the trailer 11 and is located near the front end of the trailer 11. In particular, the trailer 11 includes a floor having a sub-floor 20 and a flooring surface 22 to define the floor region 21 of the trailer 11 therebetween, as shown in FIG. 1B. Illustratively, such flooring surface 22 is removed from the trailer 11 shown in FIG. 1A in order to access the interior of the floor region 21. Further illustratively, the trailer 11 is a box or van-type trailer including sidewalls 26, a roof (not shown) coupled to the sidewalls, and doors (not shown) provided in one or more of the sidewalls 26. As is discussed in greater detail below, the trailer coupler assembly 10 includes first and second anodes 100 provided to retard the corrosion of other surrounding components of the trailer coupler assembly 10.

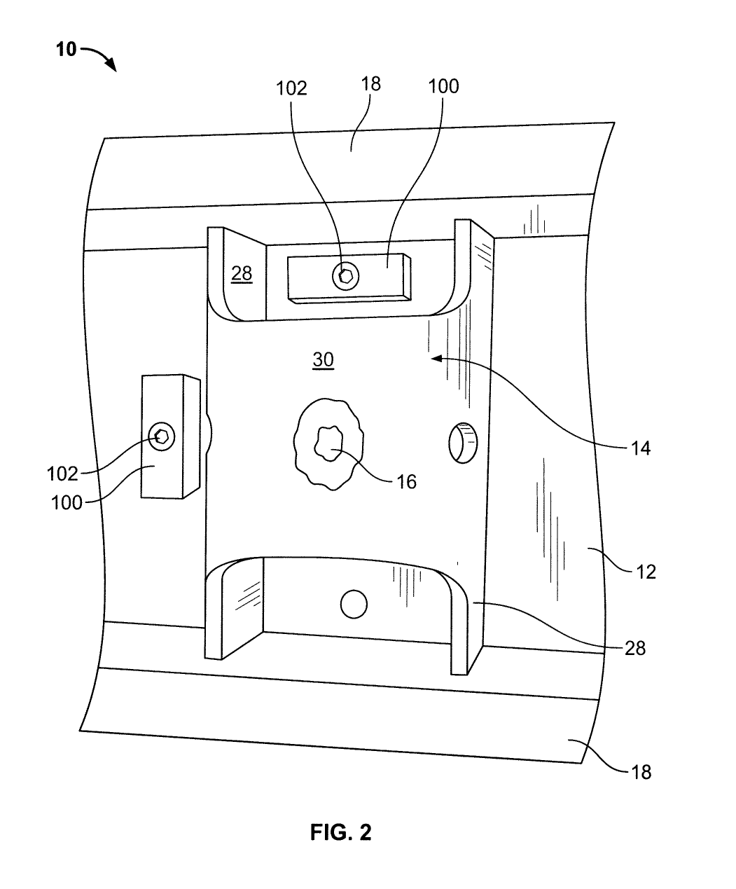

Looking now to FIGS. 1A-2, the trailer coupler assembly 10 includes a coupler grid plate 12, a support bracket 14 coupled to the plate 12, a kingpin 16 coupled to the support bracket 14 and positioned to extend downwardly from the coupler grid plate 12 as shown in FIG. 1B, a plurality of cross-members 18 coupled to the plate 12 and the bracket 14, and, optionally, a plurality of dividers 24 coupled to the plate 12 and the cross-members 18. The coupler grid plate 12 forms the base of the trailer coupler assembly 10 and the bottom surface of the coupler grid plate 12 is generally flush with the bottom surface of the sub-floor 20. The coupler grid plate 12 typically occupies substantially the entire width of the trailer 11; however, it is within the scope of this disclosure to include a trailer coupler assembly having a coupler plate of any suitable size. As shown in FIGS. 1A and 1B, a plurality of cross-members 18 is coupled to the top surface of the coupler grid plate 12. Each cross-member 18 extends laterally across the width of trailer 11. The cross-members 18 are each formed in the shape of an upside-down “U” when viewed from the end (as shown in FIG. 1B) and includes substantially flat top and side walls and rounded corners. Illustratively, as shown in FIGS. 1A and 2, the two cross members 18 are parallel to and spaced-apart from each other such that the support bracket 14 is positioned therebetween.

Looking now to FIG. 2, the support bracket 14, is generally “H-shaped” when viewed from above and is disposed in the space between the cross members 18. Illustratively, the support bracket 14 includes spaced-apart side arm portions 28 (corresponding to the vertical sides of the “H-shape”) and a bridge portion 30 (corresponding to the horizontal middle of the “H-shape”) extending between and coupled to the side arm portions 28. In particular, the bridge portion 30 is coupled to an upper end of each side arm portion 28 while a lower end of each side arm portion 28 is coupled to the grid plate 12. As such, the bridge portion 30 of the bracket 14 is spaced-apart from the coupler grid plate 12. Illustratively, the support bracket 14 is welded to the coupler grid plate 12; however, it is within the scope of this disclosure to couple the bracket 14 to the plate 12 by any other coupling structure. As is discussed in greater detail below, the support bracket 14 is coupled to the kingpin 16. While the particular support bracket 14 is shown and described herein, it is within the scope of this disclosure to include a trailer coupler assembly having any suitable bracket for coupling the kingpin 16 to the coupler plate 12.

As noted above, dividers 24 of the trailer coupler assembly 10 are illustratively positioned between the cross members 18 on either side of the support bracket 14, as shown in FIGS. 1A and 1B. Illustratively, the dividers 24 are vertical plates secured to the coupler grid plate 12, the cross members 18 and the flooring surface 22. Illustratively, because the dividers 24 span the height of flooring region 21, the dividers 24 form substantially enclosed chambers between a set of dividers 24 or between a divider 24 and the support bracket 14. Illustratively, the dividers 24 are each welded to the grid plate 12 and the cross members 18; however, it is within the scope of this disclosure to couple the dividers 24 to the plate 12 and members 18 by any other suitable coupling structure.

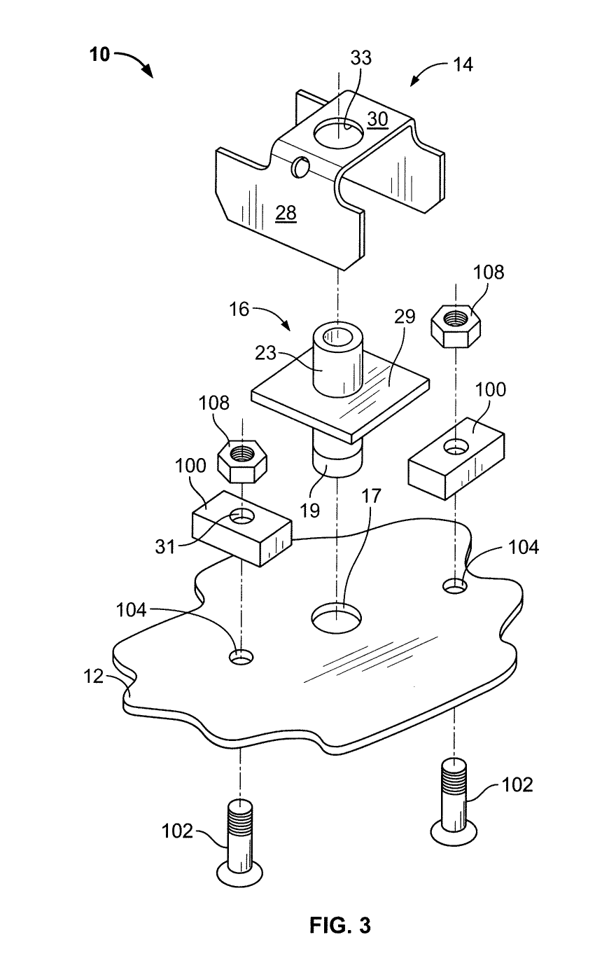

A lower portion 19 of the kingpin 16 is received through an aperture 17 in the coupler grid plate 12 and is illustratively located approximately 36 inches rearward of a front end 27 of the trailer 11, as shown in FIGS. 1B and 3. An upper portion 23 of kingpin 16 is secured to the bridge portion 30 of the support bracket 14. Illustratively, an upper edge of the upper portion 21 of the kingpin 16 is received within an aperture 33 of the bridge portion 30 and is welded thereto. An apron plate 29 of the trailer coupler assembly 10 is coupled to the kingpin 16, as shown in FIG. 3, such that the upper portion 21 of the kingpin 16 is positioned above the apron plate 29 and the lower portion 19 of the kingpin 16 is positioned below the apron plate 29. When assembled, the bottom surface of the apron plate 29 is coupled to and adjacent the top surface of the coupler plate 12. In accordance with conventional operation, the lower portion 19 of kingpin 16 interfaces with a fifth wheel (not shown) of a semi-tractor or interfaces with a stanchion plate (not shown) of a railway car, for example. Illustratively, while various components of the trailer coupler assembly 10 are shown in FIGS. 1A-3, it is within the scope of this disclosure to include alternative trailer coupler assemblies having other suitable components coupled to a trailer to permit the trailer to be coupled to a semi-truck, for example.

Illustratively, components of the trailer coupler assembly 10 including the kingpin 16, the coupler plate 12, the support bracket 14, and the apron plate 29 are conventionally made of metal and/or metallic alloys, such as steel, which have high strength and durability. As noted above, these components are welded to each other at their connections, such as at the contact between the kingpin 16 and the support bracket 14 and the contacts between the support bracket 14 and the cross members 18. However, it is within the scope of this disclosure to couple the components of the trailer coupler assembly 10 to each other using other suitable fastening structures such as bolts, screws, epoxy, etc.

Looking now to FIGS. 2 and 3, the trailer coupler assembly 10 further includes first and second zinc blocks 100 attached to the coupler grid plate 12 adjacent the support bracket 14 and the kingpin 16. Illustratively, as is described in greater detail below, the zinc blocks 100 operate as sacrificial anodes to retard (e.g., delay) or even stop the corrosion of the surrounding steel components of the trailer coupler assembly 10. Illustratively, sacrificial anodes include a metal having a more negative electrochemical reduction potential than any of the metal(s) used to form the surrounding components of the trailer coupler assembly 10 and the metal(s) used to weld the components of trailer coupler assembly 10 together. Stated differently, sacrificial anodes, such as the zinc blocks 100, include a metal that will oxidize more readily than any the metal(s) used in the components, fasteners, and/or welding adjacent to and surrounding the sacrificial anodes. Further illustratively, while the blocks 100 of the trailer coupler assembly 10 are zinc, it is within the scope of this disclosure to substitute or include other suitable metals that oxidize more readily than the metal(s) used to form the various components of the trailer coupler assembly 10. Examples include, but are not limited to, magnesium, aluminum, and alloys of zinc, magnesium, and aluminum. Furthermore, while entirety of the blocks 100 are generally formed of zinc, it is within the scope of this disclosure to include sacrificial anodes which are only partially formed of one or more of the aforementioned metals.

Illustratively, as noted above, the zinc blocks 100 operate to retard or even prevent the corrosion of the components and welds of trailer coupler assembly 10 which have a less negative electrochemical reduction potential than the electrochemical reduction potential of the zinc blocks 100. Accordingly, in the presence of an electrolyte, the zinc blocks 100 will act as the sacrificial anode of the electrochemical cell defined by the zinc blocks 100 and the surrounding components of the trailer coupler assembly 10, thus giving up metallic ions to other metals present in the trailer coupler assembly 10. The steel components of the trailer coupler assembly 10, such as the support bracket 14, the kingpin 16, the coupler plate 12 and/or the welding act as the cathode of the electrochemical cell and corrosion of these elements is retarded, perhaps even to the point of stopping, until the zinc blocks 100 have been completely corroded themselves. Generally, in order to prevent corrosion of the components of the trailer coupler assembly 10, there must be an electrical connection or ion pathway between the trailer assembly components and the zinc blocks 100. Such an electrical connection may include a series of metallic connections or immersion in the same body of electrolyte.

Referring again to FIGS. 2 and 3, the trailer coupler assembly 10 includes the first and second zinc blocks 100 attached to the coupler grid plate 12 adjacent to the support bracket 14 and the kingpin 16. As shown in FIG. 2, one of the zinc blocks 100 is coupled to the plate 12 at a location adjacent to and aligned with one of the side arm portions 28 of the support bracket 14. Illustratively, this zinc block 100 is spaced-apart from the left side arm portion 28, as shown in FIG. 2, outside the bracket 14. The other zinc block 100 is illustratively positioned between the side arm portions 28 at a location above the kingpin 16, as shown in FIG. 2. However, it is within the scope of this disclosure to couple the zinc blocks 100 to any suitable location on the coupler plate 12 in order to retard or prevent the corrosion of adjacent metal components of the trailer coupler assembly 10. For example, a zinc block may be coupled at any location inside or outside the side arms 28 of the support block 14. The zinc blocks 100 may also be attached to the coupler grid plate 12 at a location further from the bracket 14, such as within an interior portion 25 (shown in FIG. 1B) of one or more of the cross members 18. Further, the zinc blocks 100 may be positioned at a location between two adjacent dividers 24, for example.

Illustratively, as shown in FIGS. 2 and 3, each zinc block 100 is coupled to the coupler plate 12 by a bolt 102 received though through a hole 31 in the zinc block 100 and a hole 104 (shown in FIG. 3) in the coupler grid plate 12. A nut 108 is fastened to the bolt 102. Alternatively, the hole 104 may contain threading such that the bolt 102 is fastened to the coupler grid plate 12 without protruding below the bottom surface of the coupler grid plate 12. Further, the aperture 31 in the zinc block 100 may contain threading (not shown) such that the zinc block 100 is threadably coupled to a screw (not shown) with or without the use of the nut 108. Illustratively, the bolt 102 and/or the screw may be countersunk into the bottom surface of the coupler plate 12 such that the head of the bolt 102 or screw does not substantially protrude below the bottom surface of coupler grid plate 12. As one skilled in the art will appreciate, numerous structures are available to attach the zinc block sacrificial anodes 100 to the coupler grid plate 12. While the zinc blocks 100 may be attached in a permanent fashion by methods such as welding, the zinc blocks 100 in the illustrated embodiment are removably attached to the coupler grid plate 12 so that the zinc blocks 100 may be replaced when they have wholly or partially lost the ability to retard corrosion of the surrounding trailer assembly components. As such, while each zinc block 100 is illustratively coupled to the coupler plate 12 through the use of the bolt 102 or a threaded screw, it is within the scope of this disclosure to couple the zinc blocks 100 to the coupler plate 12 using other suitable fasteners such as nails, adhesives such as epoxy, welding, etc.

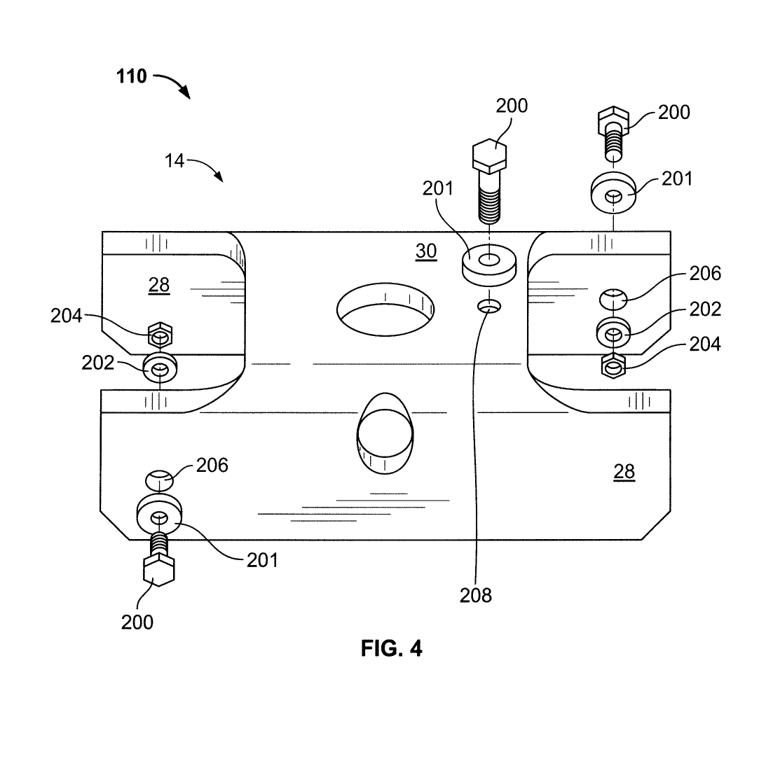

Looking now to FIG. 4, another trailer coupler assembly 110 includes the support bracket 14 as well as zinc washers 201 coupled thereto. Illustratively, the zinc washers 201 operate as the sacrifical anodes of the trailer coupler assembly 110 to retard or prevent the corrosion of adjacent components of the trailer coupler assembly 110 which are connected to one or more of the zinc washers 201 by an ion pathway. Illustratively, the trailer coupler assembly 110 includes the same or similar components as the trailer coupler assembly 10. As such, like reference numerals are used to denote like components. Illustratively, the zinc washers 201 have the same properties as those discussed above in regard to the zinc blocks 100.

As shown in FIG. 4, a zinc washer 201 is coupled to each of the side arm portions 28 of the support bracket 14. In particular, a first end of one of the side arm portions 28 includes an aperture 206 therethrough configured to receive a bolt 200 therein. The illustrative zinc washer 201 is positioned adjacent an outer surface of the support bracket 14 between the head of the bolt 200 and the side arm portion 28. A second washer 202 and a nut 204 are then coupled to the opposite end of the bolt 200 in order to secure the bolt 200 and zinc washer 201 to the support bracket 14. Similarly, a second end of the other one of the side arm portions 28 includes an aperture 206 formed therethrough as well. Another bolt 200 is received through the aperture 206 to secure another zinc washer 201 to the outer surface of the side arm portion 28. Further, yet another zinc washer 201 is coupled to the bridge portion 30 of the support bracket 14. Illustratively, an aperture 208 is formed in the bridge portion 30 in order to receive the bolt 200 therethrough to secure the zinc washer 201 to the outer surface of the bridge portion 30. Alternatively, the apertures 206, 208 may each contain threading such that the bolt 200 is able to be fastened directly to the support bracket 14 without the use of the nut 204.

While one zinc washer 201 is coupled to each of the side arm portions 28 and the bridge portion 30 of the support bracket 14 in the embodiment illustrated in FIG. 4, it is within the scope of this disclosure to couple any number of zinc washers 201 at any location on the support bracket 14. Further, it is within the scope of this disclosure to position the zinc washers 201 adjacent the inner surface of the support bracket 14 as well as the outer surface of the support bracket 14. Illustratively, the zinc washers 201 are removably attached to the bracket 14 by removable fasteners such as the bolts 200 in order to allow a user to replace the zinc washers 201 when each have wholly or partially lost the ability to retard corrosion of the other components of the trailer coupler assembly 110. However, while the zinc washers 201 are secured to the support bracket 14 by bolts 200, it is within the scope of this disclosure to secure zinc washers 201 to the support bracket 14 using other suitable fastening structures.

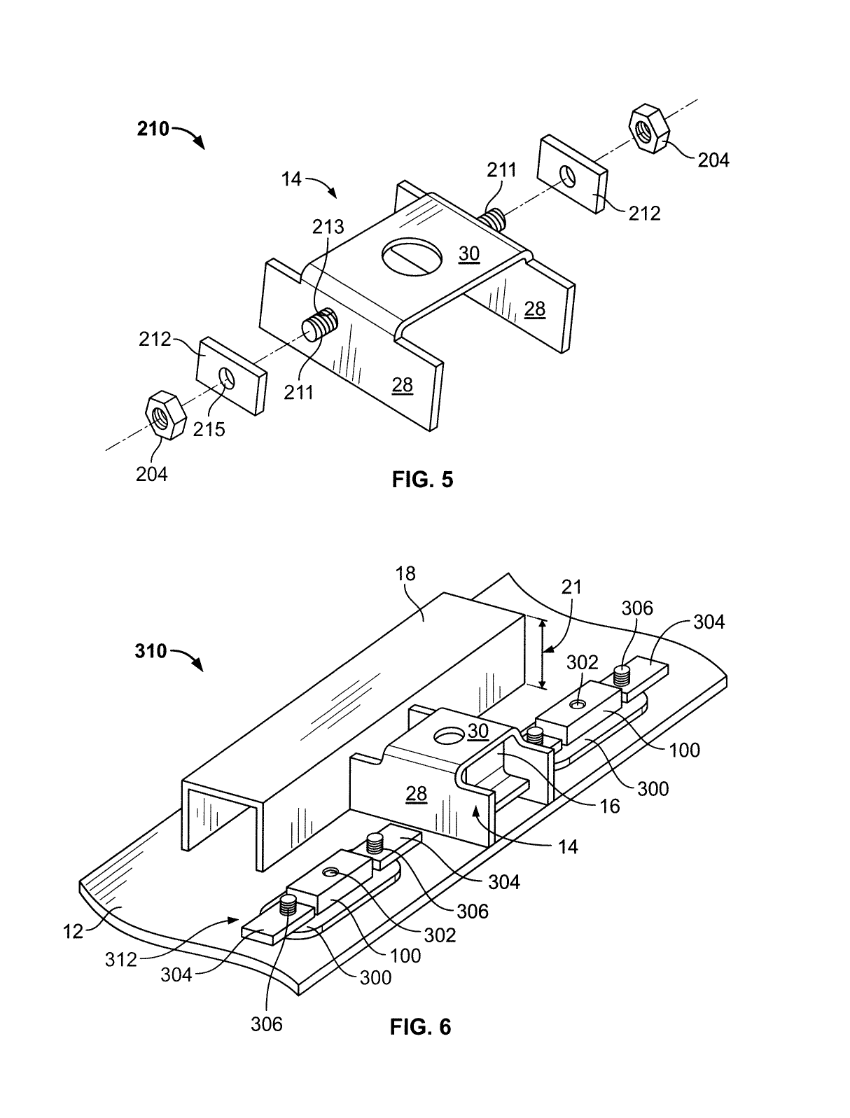

Illustratively, the zinc washers 201 of the trailer coupler assembly 110 may be any suitable shape or size. For example, as shown in FIG. 5, a trailer coupler assembly 210 includes the support bracket 14 and zinc block washers 212 coupled thereto. In particular, the support bracket 14 includes an aperture 213 formed through each support arm 28. Illustratively, the aperture 213 is generally centrally located along the length of the support arm 28; however, it is within the scope of this disclosure for each support arm 28 to include an aperture at any suitable location. Illustratively, as shown in FIG. 5, a screw 211 is received through the aperture 213 in each arm portion 28 of the support bracket 14. Each screw 211 is further received through an aperture 215 of the respective zinc block washer 212 coupled thereto such that each zinc block 212 is coupled to and engaged with the outer surface of the respective one of the side arm portions 28 to which it is coupled. Each zinc block washer 212 is secured to the screw 211 by a nut 204. Alternatively, the aperture 215 of the zinc block washers 212 may be threaded such that each zinc block washer 212 may be threaded onto the respective screw 211 and secured thereto without the use of the nut 204. Further illustratively, the screw 211 may be a threaded protrusion of the support bracket 14 extending outwardly and integrally formed as part of each side portion 28 for receiving a zinc block washer 212 thereon. As one skilled in the art will appreciate, bolts, screws, and other devices which permenantly or removably fasten the zinc blocks 212 to the bracket 14 may be alternatively or additionally used.

Looking now to FIGS. 6-8, another trailer coupler assembly 310 includes first and second zinc block (or anode) assemblies 312 coupled to the coupler plate 12 on either side of the support bracket 14. Illustratively, each zinc block assembly 312 includes an access plug or base plate 300 received within a similarly-shaped cut-out portion 308 formed in the coupler plate 12, first and second tabs 304 coupled to the coupler plate 12 adjacent each cut-out portion 208, and a zinc block 100 coupled to the access plug 300. Illustratively, while the assemblies 312 are positioned on either side of the support bracket 14, such assemblies 312 may also be positioned at other locations on the coupler grid plate 12. For example, the assemblies 312 may be located within the interior portion 25 of one of the cross members 18 or adjacent one of the dividers 24 of the trailer coupler assembly. In other words, the assemblies 312 may be positioned in any suitable location on the trailer coupler assembly 310.

Illustratively, the access plugs 300 received within the cut-out portions 308 may be cut directly from the coupler grid plate 12 during manufacturing of the trailer coupler assembly 310 or may be independently formed of the same or a different metal or alloy, as the coupler plate 12 itself. Illustratively, the access plugs 300 and corresponding cut-out portions 308 are generally oval in shape. However, it is within the scope of this disclosure to include access plugs of any suitable shape or size. For example, the access plugs may be circular, rectangular, square-shaped, etc.

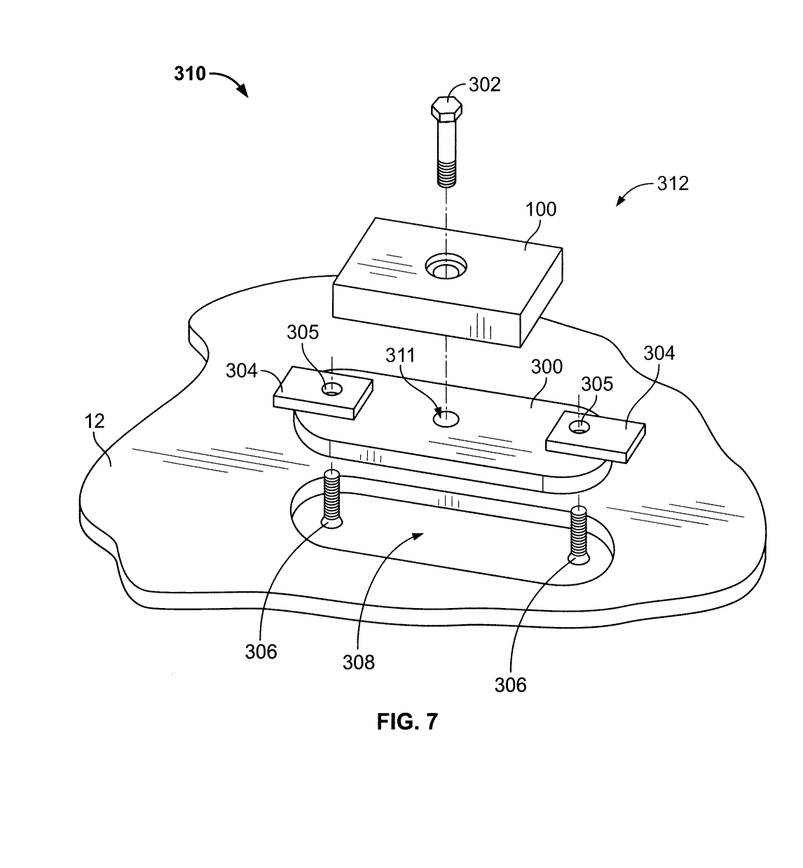

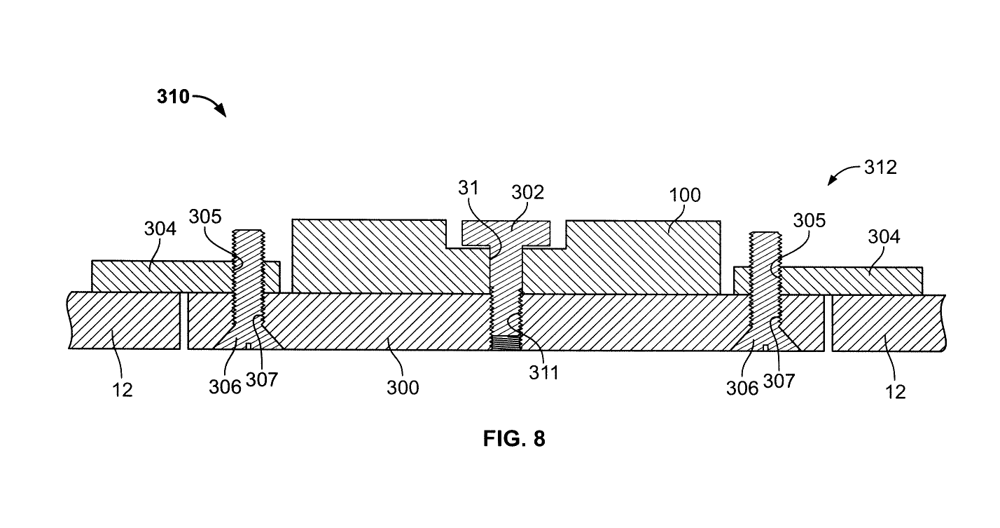

Referring now to FIGS. 7 and 8, the access plug 300 of each assembly 312 is removably positioned within the cut-out 308 formed in the coupler plate 12. Illustratively, a first end of each tab 304 is welded to the grid plate 12 adjacent the cut-out 308 such that a second end of each tab 304 is positioned over the cut-out 308, as shown in FIG. 8. While the tabs 304 are welded to the grid plate 12, it is within the scope of this disclosure to couple the tabs 304 to the grid plate 12 using other suitable fasteners such as screws, bolts, adhesives, etc. Each tab 304 further includes an aperture 305 through the second end of the tab 304 located above the cut-out portion 308. In use, the access plug 300 is coupled to the tabs 304 via a screw 306 received through an aperture 307 in the access plug 300 and the aperture 305 of the respective tab 304, as shown in FIG. 8. Illustratively, the screw 306 is countersunk into the apertures 307 of the access plug 300 such that when each assembly 312 is assembled, the bottom surface of the each access plug 300 is substantially flush with the bottom surface of the coupler grid plate 12. Further illustratively, while a screw 306 is used to fasten the access plug 300 to the tabs 304, other suitable fasteners may be used as well. Further, while each assembly 312 includes two tabs 304 and two screws 306, as shown in FIGS. 7 and 8, it is within the scope of this disclosure to include an assembly having more or fewer such tabs and screws to removably couple the access plug 300 to the coupler plate 12.

Illustratively, the access plugs 300 are removably disposed in the coupler grid plate 12, such that servicing of the trailer coupler assembly 10, including replacing the zinc blocks 100, may be performed from beneath the trailer 11. As noted above, the zinc blocks 100 will wholly or partially lose the ability to protect against corrosion due to ion migration over time and should, therefore, be periodically replaced in order to continue to prevent or retard corrosion of surrounding components of the trailer coupler assembly. However, the coupler grid plate 12, cross members 18, and flooring surface 22 (as shown in FIGS. 1A and 1B) generally form the closed floor region 21 which may not be easily accessed. Access plugs 300 may be removed from the underside of the coupler grid plate 12 (also the underside of the trailer) so that the zinc block sacrificial anodes 100 may be serviced. Illustratively, access plugs 300 are attached to the trailer coupler assembly 10 such that they are secure when the trailer is in operation, but may be easily removed for servicing when desired.

While the removable access plugs 300 may allow for servicing of any portion of a trailer coupler assembly in order to replace any of the sacrificial zinc anodes attached to the coupler grid plate 12 and the support block 14 as described above, the zinc block 100 of each assembly 312 is also removably attached directly to the top surface of each respective access plug 300, as shown in FIGS. 6-8. Thus, when an access plug 300 is removed from the trailer coupler assembly 10, the zinc block 100 is also removed from the access plug 300 and the zinc block 100 may be serviced or replaced at a remote location before the access plug 300 is reattached with a new zinc block 100. Illustratively, the zinc block 100 of each assembly 312 is illustratively coupled to the access plug 300 via a bolt 302 received through the aperture 31 of the zinc block 100 and a central aperture 311 formed in the access plug 300. Alternatively, the aperture 311 may contain threading such that the bolt 302 is fastened to the access plug 300 without protruding below the bottom surface of the access plug 300 or the coupler grid plate 12. As one skilled in the art will appreciate, bolts, screws, and other devices which removably fasten the sacrificial anode 100 to the access plug 300 may be alternatively or additionally used as well.

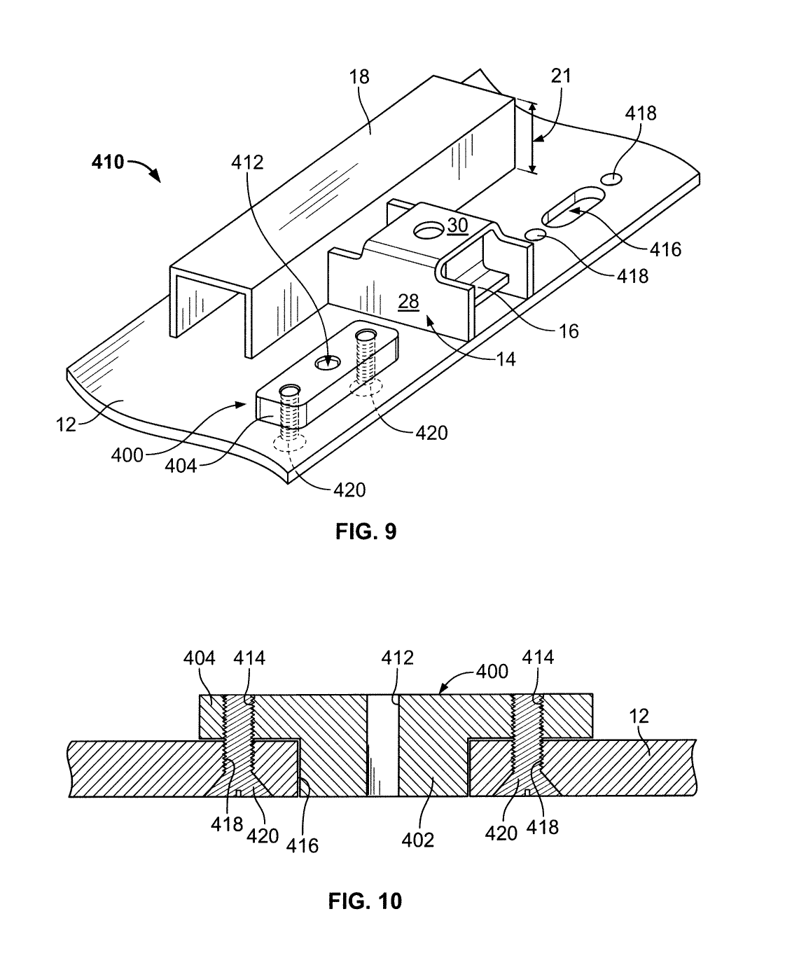

Looking now to FIGS. 9 and 10, yet another trailer coupler assembly 410 is provided. Illustratively, the trailer coupler assembly 410 includes many of the same or similar components as the trailer coupler assemblies 10, 110, 210, and 310 described above. As such, like reference numerals are used to denote like components. Illustratively, the trailer coupler assembly 410 includes a zinc block 400 coupled to the coupler grid plate 12. As shown in FIG. 10, the zinc block 400 is generally “T-shaped” when viewed in cross-section and includes a vertical leg member 402 and an upper, horizontal member 404 coupled to the leg member 402. Illustratively, the vertical and horizontal members 402, 404 of the zinc block 400 are formed integrally with each other such that the zinc block 410 forms a unitary component; however, the members 402, 404 may be separately formed and coupled together to define the zinc block 400 as well. The zinc block 400 further includes a central bore 412 formed through the members 402, 404, as shown in FIG. 10 as well as first and second side apertures 414 formed through each end of the horizontal member 404.

Illustratively, the coupler grid plate 12 of the trailer coupler assembly 410 includes a cut-out 416 on either side of the support bracket 16. Further, the coupler grid plate 12 includes an aperture 418 on each side of each cut-out 416. In use, the vertical leg member 402 of each zinc block 400 is received through one of the cut-outs 416 formed in the coupler grid plate 12. Each cut-out 416 is generally oblong or oval-shaped in order to match the generally oval-shaped cross-section of the vertical member 402 of each zinc block 400. However other suitable shapes may be alternatively or additionally used as well. Illustratively, the bottom surface of the horizontal member 404 of each zinc block 400 is adjacent to and engaged with the top surface of the coupler grid plate 12 such that the apertures 414 of each zinc block 400 are generally aligned with the apertures 418 formed in the coupler grid plate 12. Further, the bottom surface of the vertical member 402 is generally flush with the bottom surface of the coupler grid plate 12, as shown in FIG. 10. Illustratively, a fastener 420 is countersunk into the apertures 418 of the coupler grid plate 12 such that the fastener 420 is substantially flush with the bottom surface of the coupler grid plate 12. Illustratively, the fastener 420 is a self-threaded screw; however, as one skilled in the art will appreciate, bolts and nuts, blind fasteners, and other devices which permenantly or removably fasten the zinc blocks 400 to the coupler grid plate 12 may be alternatively or additionally used. In particular, one or more of the apertures 418 of the coupler grid plate 12 and the apertures 414 of each zinc block 400 may be threaded in order to receive a threaded screw therein.

As noted above, each zinc block 400 includes a center bore 412 therethrough. In use, the center bore 412 allows an operator or other technician to view and inspect the interior of the floor region 21 of the trailer coupler assembly 410 while the zinc blocks 400 are installed.

Illustratively, the sacrificial anodes 100, 201, 212, 400 shown in FIGS. 1A-10 are generally rectangular in shape, cylindrical in shape, or are T-shaped. However, it should be understood that sacrificial anodes of any suitable shape and size may be alternatively used with the trailer coupler assemblies 10, 110, 210, 310, 410 of the present disclosure. For example, sacrificial anodes having rectangular, cubic, cylindrical, oval, and other configurations or combinations thereof may be used.

Further, while each of the sacrificial anodes 100, 201, 212, 400 is fastened to another one of the respective trailer coupler assembly components, such as the coupler plate 12 and the support bracket 14, using bolts or screws, it is within the scope of this disclosure to position sacrificial anodes within enclosed compartments of a trailer coupler assembly as well. In particular, a plurality of sacrificial anodes may be disposed loosely within a substantially enclosed chamber formed between a set of two adjacent dividers 24 or between a divider 24 and the support bracket 14. Further illustratively, one or more sacrificial anodes may be positioned loosely within the interior portion 25 of the cross-members 18.

It should also be understood that the structure for attaching the sacrificial anodes 100, 201, 212, 400 to the trailer coupler assemblies 10, 110, 210, 310, 410 described in the various illustrative embodiments and illustrated in FIGS. 1-10 may be used in conjunction with one another and/or with other attachment structures. For example, one or more sacrificial anodes 100, 201, 212, and/or 400 may be attached to the coupler grid plate 12, one or more sacrificial anodes 100, 201, 212 and/or 400 may be attached to the support bracket 14, and one or more sacrificial anodes 100, 201, 212 and/or 400 may be attached to one or more respective access plugs 300.

Further, as noted above, while the sacrificial anodes 100, 201, 212, 400 are illustratively coupled to the coupler grid plate 12, the support bracket 14, and the access plug 300, such anodes 100, 201, 212, 400 may be coupled to other components of the assemblies 10, 110, 210, 310, 410 as well. For example, one or more sacrificial anodes 100, 201, 212, 400 may be coupled to the kingpin 16, the apron plate 29 around the kingpin 16, the cross-members 18, and/or the dividers 24, for example. Accordingly, the sacrificial andoes may be coupled directly or indirectly to any suitable component of the trailer coupler assembly.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A trailer coupler assembly comprising:
a coupler grid plate,
a support bracket coupled to the grid plate,
a kingpin coupled to the coupler grid plate and the support bracket, the kingpin being positioned to extend below a bottom surface of the coupler grid plate, and
a sacrificial anode coupled to one of the coupler grid plate and the support bracket.

2. The trailer coupler assembly of claim 1, wherein the sacrificial anode is removably coupled to the coupler grid plate.

3. The trailer coupler assembly of claim 2, wherein the sacrificial anode is positioned between two side arms of the support bracket.

4. The trailer coupler assembly of claim 2, wherein the sacrificial anode is bolted to the coupler grid plate.

5. The trailer coupler assembly of claim 2, further comprising an anode assembly including a base plate received within a cut-out portion of the coupler grid plate, and a fastener configured to removably fasten base plate to the coupler grid plate, wherein the sacrificial anode is coupled to the base plate.

6. The trailer coupler assembly of claim 5, wherein the fastener of the anode assembly includes a tab coupled to the coupler grid plate and removably coupled to the base plate.

7. The trailer coupler assembly of claim 5, wherein the base plate and the coupler grid plate are substantially flush with each other when the base plate is coupled to the coupler grid plate.

8. The trailer coupler assembly of claim 1, wherein the kingpin is made of a first metal or metal alloy and the sacrificial anode is made of a second metal or metal alloy having a lower reduction potential than the first metal or metal alloy.

9. The trailer coupler assembly of claim 1, wherein the sacrificial anode includes one of zinc, magnesium, and aluminum.

10. The trailer coupler assembly of claim 9, wherein the sacrificial anode is a block of zinc.

11. The trailer coupler assembly of claim 1, wherein the sacrificial anode is coupled to the support bracket.

12. The trailer coupler assembly of claim 11, wherein the sacrificial anode is a washer coupled to the support bracket by a fastener received through an aperture of the washer and an aperture of the support bracket.

13. The trailer coupler assembly of claim 12, wherein the washer includes zinc.

14. The trailer coupler assembly of claim 1, wherein the sacrificial anode is generally T-shaped.

15. The trailer coupler assembly of claim 14, wherein the coupler grid plate includes a cut-out formed therethrough, and a portion of the zinc block is received within the cut-out such that a bottom surface of the sacrificial anode is generally flush with a bottom surface of the coupler grid plate.

16. A sacrificial anode assembly configured to be coupled to a coupler grid plate of a trailer, the sacrificial anode assembly comprising:
a base plate configured to be received within an aperture formed in the coupler grid plate;
a fastener including a tab configured to be coupled to the coupler grid plate and removably coupled to the base plate to removably secure the base plate to the coupler grid plate; and
a sacrificial anode coupled to the base plate.

17. A method of preventing corrosion of a trailer coupler assembly comprising:
forming a cut-out portion in a coupler grid plate of the trailer coupler assembly;
positioning a base plate within the cut-out portion of the coupler grid plate;
removably coupling the base plate to the coupler grid plate; and
coupling a first sacrificial anode to the base plate.

18. The method of claim 17, further comprising removing the base plate from the coupler grid plate, replacing the first sacrificial anode on the base plate with a second sacrificial anode after the first sacrificial anode has been used, and recoupling the base plate to the coupler grid plate.

19. The method of claim 17, wherein removably coupling the base plate to the coupler grid plate includes coupling a fastener to the coupler grid plate and coupling the base plate to the fastener.

20. The method of claim 19, wherein the fastener is a tab having a first end welded to the coupler grid plate and a second end removably coupled to the base plate.
